(19) United States
(12) Patent Application Publication
(10) Pub. No.: US 2007/0219758 A1
(43) Pub. Date: Sep. 20, 2007

(54) Processing sensor data from a downhole device

(76) Inventor: Dwight A. Bloomfield, Sand Springs, OK (US)

Correspondence Address: SHOOK, HARDY & BACON LLP;INTELLECTUAL PROPERTY DEPARTMENT, 2555 GRAND BLVD, KANSAS CITY, MO, 64108-2613, US

(21) Appl. No.: 11/378,533

(22) Filed: Mar. 17, 2006

(51) Int. Cl. G06F 19/00; G06F 17/40

(52) U.S. Cl. 702/190; 702/1; 702/6; 702/127; 702/189

(57) ABSTRACT

A system, a device and a method for processing sensor data generated by a downhole device located in a wellbore. A wavelet transformation is applied to the sensor data to generate a set of filtered data. Data points from the filtered data are removed to yield a reduced dataset. When desired, the original sensor data is reproduced by applying an inverse wavelet transformation to the reduced dataset.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Modern petroleum drilling and production operations demand a great quantity of information relating to parameters and conditions downhole. Such information may include characteristics of the earth formations traversed by the wellbore, in addition to data relating to the size and condition of the borehole itself. The collecting of information relating to conditions downhole is commonly is referred to as “well logging.”

Well logging can be performed by several methods and has been known in the industry for many years. In conventional well logging, a probe or “sonde” is lowered into the borehole after at least some of the well has been drilled. The sonde is used to determine certain characteristics of the formations traversed by the borehole and/or characteristics of the well itself. The sonde may include sensors to measure parameters downhole and typically is constructed as a hermetically sealed cylinder for housing the sensors. In accordance with conventional techniques, various parameters are measured and correlated with the position of the sonde in the borehole as the sonde is pulled uphole or pushed downhole.

The sonde may hang at the end of a long cable. In some logging operations, this cable is referred to as a “wireline.” A wireline may provide mechanical support and operating power to the sonde. The wireline may also provide a connection between the sensors and equipment located at the surface of the well. So the wireline may be used to transmit information signals from the sonde to the surface in real-time.

Alternatively, the cable may be a “slickline.” Slicklines differ from wirelines in that slicklines generally do not transmit information signals from the sonde to the surface. Instead, when using a slickline, sensor data is stored in a memory location (i.e., a data store) residing within the sonde. The sensor data may be retrieved when the sonde is returned to the surface, and this type of logging is referred to as “memory logging.”

There are various types of logging operations. For example, logging while a well is in production is called “production logging.” As another example, “logging while drilling” (LWD) or “measuring while drilling” (MWD) may be used when formation properties are needed while a well is being drilled. To perform LWD/MWD, sensors are deployed near the end of an active drilling string. Another type of logging is referred to as “open-hole logging.” To perform open-hole logging, acoustic measurements are taken in a wellbore before a well is cased with cement. Open-hole logging may be used to determine formation properties such as the viscosity of the rocks.

Another exemplary type of logging is referred to as “bond logging.” Bond logging seeks to measure the bond between the casing and the cement placed in the annulus between the casing and the wellbore. These measurements may be made by using acoustic sonic and/or ultrasonic tools. For example, the measurements may be displayed on a cement bond log in millivolt units, decibel attenuation, or both. Reduction of the reading in millivolts or increase of the decibel attenuation is an indication of better-quality bonding of the cement behind the casing to the casing wall.

Regardless of which type of logging is being attempted, there are currently inadequate techniques in the art for retrieving sensor data from a downhole device. For example, memory logging does not allow real-time transmission of the sensor data. Further, memory logging is limited by the amount of memory physically present on the downhole device. With the large quantity of digital data generated by logging operations, such on-device memory may be quickly consumed.

The transmission of sensor data via a wireline is also problematic. Wirelines have limited bandwidth and cannot adequately carry the large amounts of data generated by logging operations. Further, the quality of transmission on these lines is poor, and wirelines tend to distort the carried data. While some techniques exist in the art for improving the performance of wireline transmissions, such techniques are too expensive and impractical for many well loggers. Accordingly, there exists a need in the art for improved techniques for handling sensor data generated by downhole logging instruments.

### SUMMARY

The present invention meets the above needs and overcomes one or more deficiencies in the prior art by providing systems and methods for processing sensor data generated by a downhole device. A wavelet transformation is applied to the sensor data to generate filtered data. Data points from this filtered data are removed to yield a reduced dataset. For example, by leveraging the properties of wavelet transformations, unnecessary and/or unwanted data points may be identified and eliminated from the filtered data, while meaningful data points are retained. When desired, the original sensor data is reproduced by applying an inverse wavelet transformation to the reduced dataset. This reproduced sensor data may, for example, be used in the creation of well logs.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 illustrates a schematic diagram of an exemplary logging environment suitable for use in implementing one or more embodiments of present invention;

FIG. 2 illustrates a method in accordance with one embodiment of the present invention for processing sensor data generated by a downhole device;

FIGS. 3A-3C are graphs illustrating datasets generated in accordance with one embodiment of the present invention;

FIG. 4 is a schematic diagram illustrating a system for reducing sensor data generated by a downhole device; and

FIG. 5 is a schematic diagram illustrating a data processing device for processing sensor data while a downhole device is located in a wellbore.

### DETAILED DESCRIPTION

The subject matter of the present invention is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

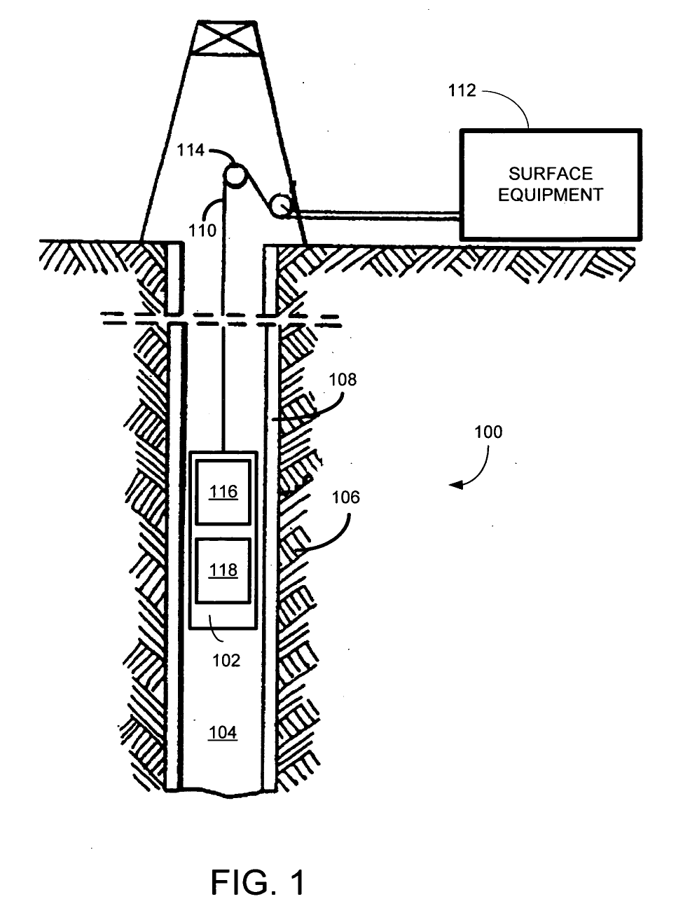

The present invention provides an improved system and method for processing data generated by a downhole sensor. Referring initially to FIG. 1, an exemplary environment for implementing the present invention is shown and designated generally as a logging environment 100. The logging environment 100 is but one example of a suitable environment and is not intended to suggest any limitation as to the scope of use of the invention. Neither should the logging environment 100 be interpreted as having any dependency or requirement relating to any one or combination of components illustrated.

A sonde 102 for acquiring logging data is located in a borehole 104 penetrating an earth formation 106. Optionally, the borehole wall may have a casing 108 cemented thereto, e.g., in a production well. In this case, the sonde 102 may be used, for example, in segmented bond logging and/or production logging. Alternately, the borehole wall may not have the casing 108. In this instance, the sonde 102 may be used to perform open-hole logging. The sonde 102 is preferably lowered in the borehole 104 by a cable 110 and is slowly raised by surface equipment 112 over a sheave wheel 114 while logging data is recorded.

The sonde 102 includes sensor equipment 116. In one embodiment, the sensor equipment 116 acquires log data by emitting an acoustic pulse or other signal and recording its return waveform. The sensor equipment 116 may include a signal source, or transmitter, and at least one detector/receiver. The source typically produces a pulse that travels through the casing 108, the formation 106 and back to the sonde 102, where it is detected by the sensor equipment 116. The return waveform may indicate characteristics of interest to a well logger and, thus, may be stored as sensor/log data. As will be appreciated by those skilled in the art, a variety of techniques exist for generating sensor/log data within a borehole, and any number of these techniques may be implemented within the logging environment 100.

Regardless of the type of logging being performed, the sensor equipment 116 will generate data to be used in logging, i.e., for evaluating the well and/or the formation 106. This sensor data may be stored on a memory unit 118, which resides within the sonde 102. As previously mentioned, this type of logging is referred to as memory logging, and it requires retrieval of the data from the memory unit 118 once the sonde 102 has returned to the surface. Alternatively, the cable 110 may include a wireline that carries the sensor data in real-time for storage and processing by the surface equipment 112.

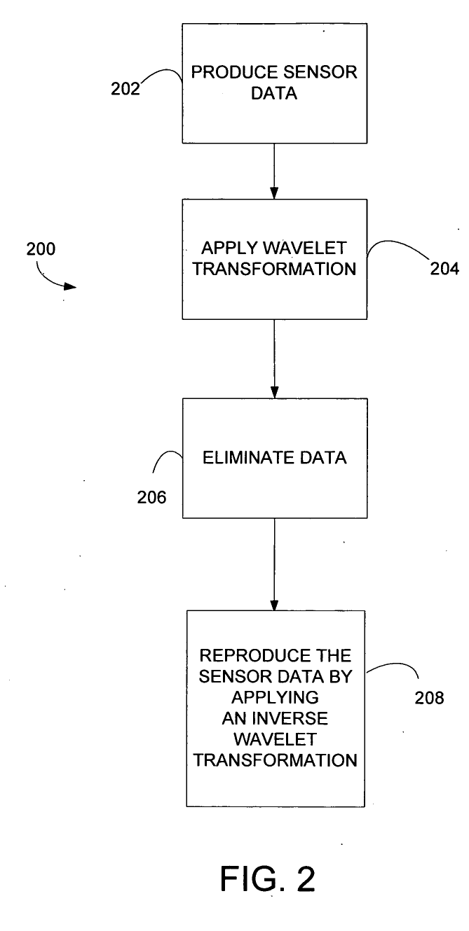

FIG. 2 illustrates a method 200 for processing sensor data generated by a downhole device. Any number of downhole devices may be utilized along with the present invention. For example, the downhole device may be the sonde 102 of FIG. 1. The downhole device may have a variety of instruments within or on the device. For example, the device may have drilling equipment for use in drilling a borehole. Further, the downhole device may have sensor equipment configured to generate data for use in well logging. As will be appreciated by those skilled in the art, the downhole device may be used in any number of logging operations, including bond logging, open-case logging and/or production logging.

At a step 202, the method 200 receives sensor data produced by the downhole device. The sensor data may be generated by a variety of means, depending upon the equipments utilized and the type of logging being attempted. For example, the downhole device may have a transmitter for emitting signals (e.g., acoustic or ultrasonic signals) and a receiver to receive the signals after they have traveled through the formation and/or the well. As will be appreciated by those skilled in the art, well loggers can discern characteristics of formations/wells from the received signals. In one embodiment, the data received by the receiver is converted into digitized sensor data by an analog-to-digital converter.

At a step 204, the method 200 applies a wavelet transformation to the sensor data to generate a set of filtered data. Wavelet transformations are mathematical transformations known in the art. For example, wavelet transformations have been used in image and audio compression, as well as data filtering and data set reduction operations. Typically, a wavelet transformation (or wavelet filter) transforms data into a wavelet domain (e.g., a spatial domain or a frequency domain). Once in this domain, non-necessary coefficients may be eliminated to yield a reduced data set. In one embodiment, a filter applies the wavelet transformation by performing a set of mathematical operations with respect to the sensor data. For example, a wavelet transformation from the Daubechies family of wavelet functions may be applied to the sensor data. When access to the original informational content is desired, an inverse wavelet transformation may be performed to recreate the original data with minimal distortion. Accordingly, wavelet transformations may be used to reduce the number of data points needed to represent an original data set.

Application of the wavelet transformation yields a set of filtered data. For example, the original sensor data may have represented the received signal in terms of amplitude and time, and the original data may have included 1024 data points. After applying the wavelet filter, the filtered data will still have 1024 data points, but it will represent the data in terms of the amplitude of the filter response verses location (e.g., in a spatial domain).

At a step 206, the method 200 eliminates data points from the filtered dataset to yield a reduced dataset. For example, the filtered data can be manipulated for data set reduction purposes. As previously mentioned, both the original sensor data and the filtered data will generally have the same number of data points. However, because of the nature of wavelet transformations, many values in the filtered dataset will have amplitude values of zero or values very close to zero. Such values may be identified as non-necessary coefficients and can be eliminated. As will be appreciated by those in the art, over ninety percent of the values in the filtered dataset may approach zero and, thus, may be eliminated at the step 206. So the reduced dataset may enjoy a ninety percent reduction in size while maintaining the meaningful data needed for accurate reproduction of the original sensor data.

Data points associated with noise similarly may be eliminated from the filtered data at the step 206. In one embodiment, filtered data points located beyond a predetermined threshold may be eliminated from the dataset. For example, all data points with a location value over 200 may indicate unwanted noise and, thus, may be eliminated. These data points may indicate high frequency responses that are known in the art to be noise and not signals of interest. It should be noted that the foregoing examples of dataset reduction by minimum amplitude removal and truncation based on location are provided as merely examples of how the filtered data may be reduced by leveraging the properties of wavelet transformations. As will be appreciated by those skilled in the art, the present invention is not limited to any specific dataset reduction techniques, and data points may be eliminated from the filtered data by any number of techniques known in the art.

The method 200, at a step 208, reproduces the sensor data by applying an inverse wavelet transformation to the reduced dataset. Wavelet transformations typically have a corresponding inverse transformation that may be used to accurately recreate the original data. For example, a wavelet transformation may be considered an encryption algorithm capable of representing data as a set of encrypted values. To decipher the data, the corresponding inverse wavelet transformation must be applied as a decryption algorithm. Thus, by applying the proper inverse transformation, the original sensor data may be accurately reproduced from the reduced dataset by the method 200.

In, one embodiment, the reduced dataset is stored in a memory location on the downhole device (i.e., memory logging). As this reduced dataset may be significantly smaller than the original set of sensor data, the amount of memory capacity required for its storage will be minimized. When the downhole device is returned to the surface, the reduced dataset may be retrieved from the memory, and the sensor data may be reproduced. In another embodiment, the reduced dataset may be transmitted via a wireline to surface equipment for data reproduction. Because of the dataset reduction, a convention wireline may be able to easily carry this data. As will be appreciated by those skilled in the art, the present invention may greatly reduce the volume of logging data generated by a downhole device and may allow well loggers to easily store/transmit the data necessary for their logging operations.

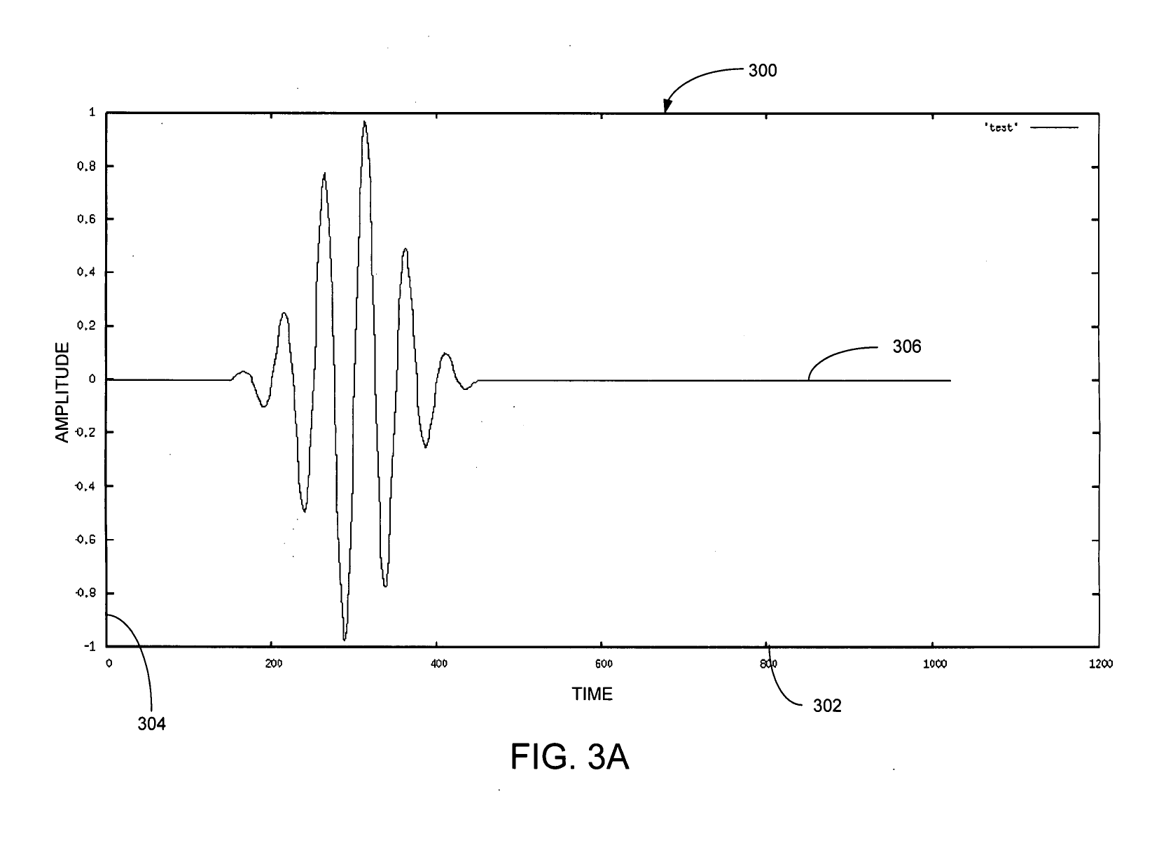

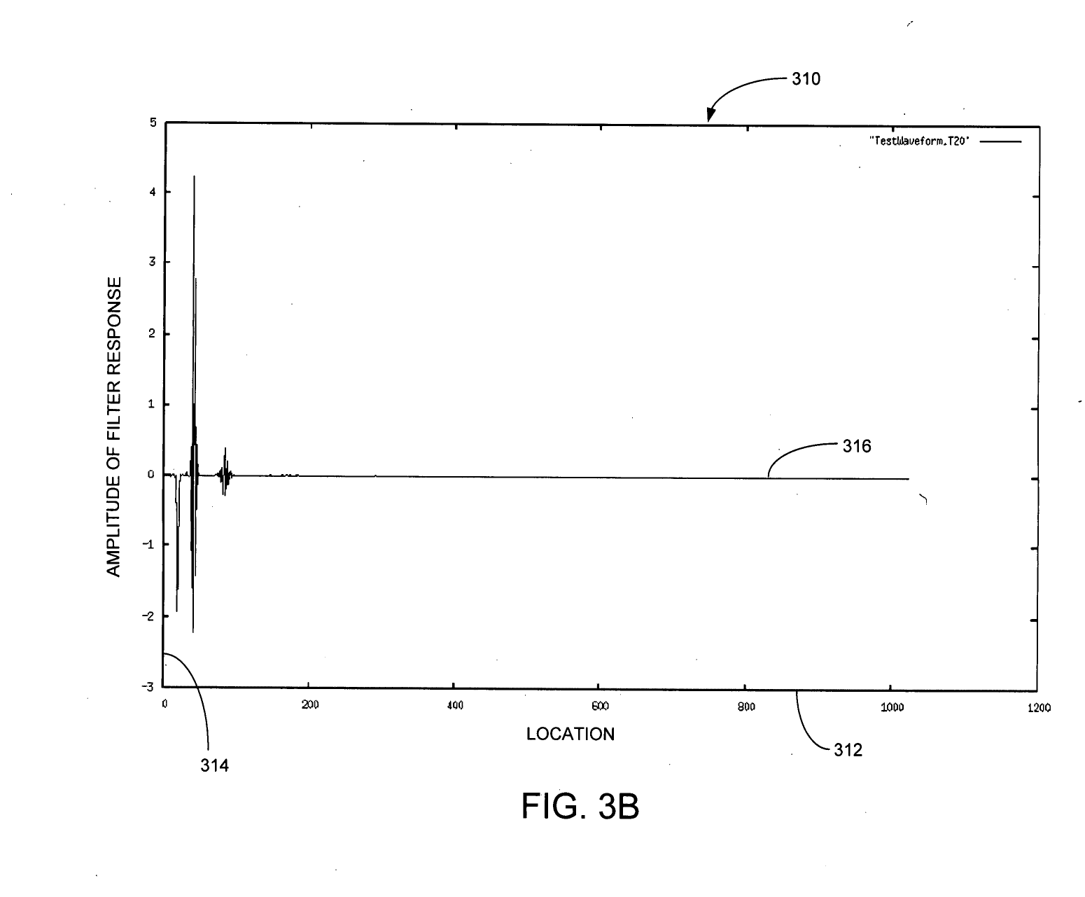

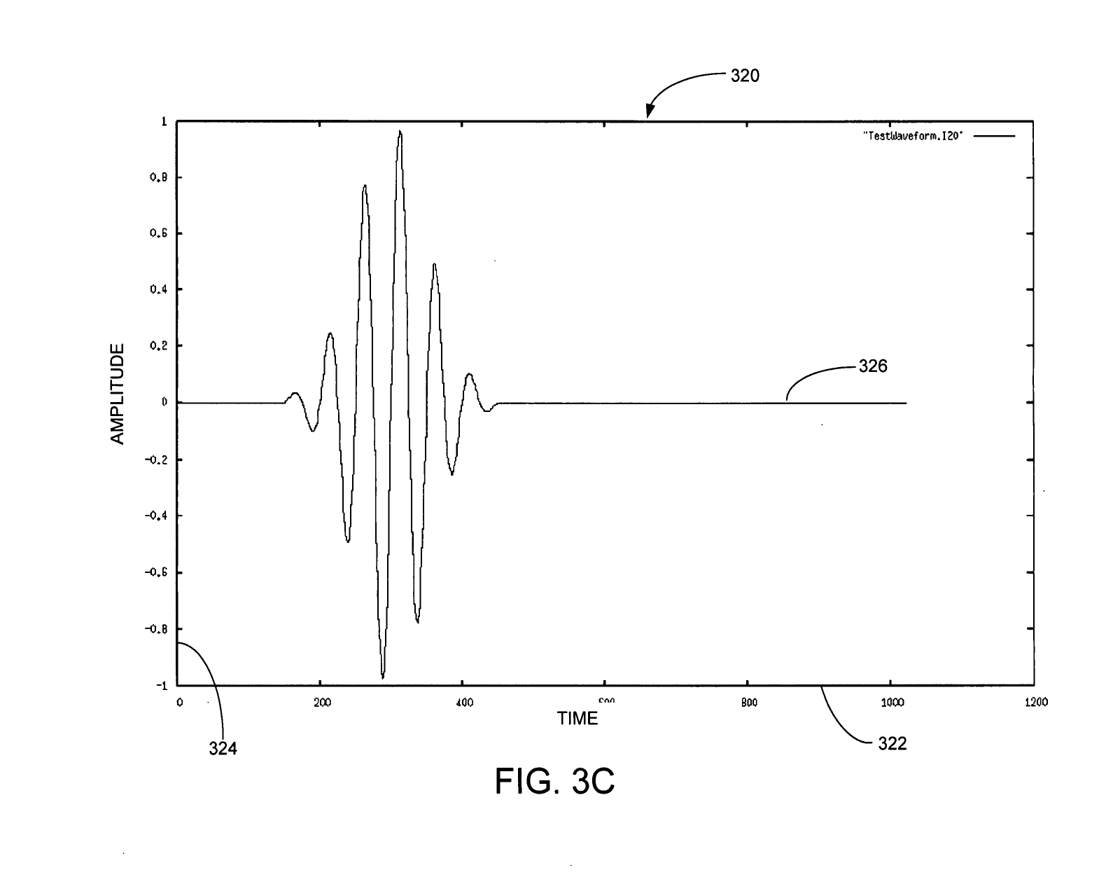

FIGS. 3A-3C are graphs illustrating datasets generated in accordance with one embodiment of the present invention. Turning initially to FIG. 3A, a graph 300 is presented. The graph 300 includes an x-axis 302 representing time values and a y-axis 304 representing amplitude values. A plot 306 illustrates received sensor data. For example, the plot 306 may include data generated from any number of logging/sensing operations. The plot 306 may be comprised of a plurality of digitized data points (i.e., points having x and y coordinates). For example, a downhole transmitter may have emitted a signal, such as a sinusoidal waveform. After the signal traveled through the formation and/or the well, a receiver may have sampled the signal's amplitude once every millisecond, and these amplitude values may be used to create the plot 306.

FIG. 3B illustrates a graph 310. The graph 310 displays the effect of applying a wavelet transformation to the data presented on FIG. 3A. The graph 310 includes an x-axis 312 representing location values and a y-axis 314 representing the amplitude of the filter response. A plot 316 represents the values of the resulting filter coefficients. While the plot 316 has the same number of data points as the plot 306 of FIG. 3A, the vast majority of the amplitude values on the plot 316 are substantially zero. As previously discussed, these values may be discarded when storing the data to yield a reduced dataset.

The graph 310 may also be used to eliminate noise from the data. Filtered values have a location above a certain threshold may be identified as representing noises. For example, all data points having a location value above 200 may be identified as representing noise and, thus, may be eliminated. Considering the plot 316, all of the amplitude values associated with positions 200-1000 appear to be zero. So the plot 316 indicated there is minimal (if any) noise present in the original sensor data.

Comparing the plot 316 to the plot 306 of FIG. 3A, it can be quickly recognized how the wavelet transformation allows for dataset reduction. The plot 306 experiences non-zero amplitude responses for approximately 300 data points. In contrast, the plot 316 includes non-zero amplitude responses for less than 100 data points. So by eliminating the data points associated with zero amplitude responses, the size of the dataset may be reduced by at least two-thirds.

Another advantage of wavelet filtering is encryption. Comparing the plots 306 and 316, the plot 316 bears no resemblance to the plot 306. As known in the art, there is no way to discern the values of the plot 306 without knowledge of the specific wavelet transformation used to create the plot 316, and, thus, the wavelet filtering may be used as an encryption algorithm suitable for protecting sensitive logging data information.

FIG. 3C illustrates a graph 320 that displays the result of applying the inverse wavelet transformation to the reduced dataset. Like the graph 300 of FIG. 3A, the graph 320 includes an x-axis 322 representing time values and a y-axis 324 representing amplitude values. A plot 326 illustrates the resulting data points. Though only the reduced dataset was used in creating the plot 326, it is substantially similar to the plot 306 of FIG. 3A. So the plot 326 accurately portrays the original data of FIG. 3A, despite having been generated from only a fraction of the original converted analog to digital information.

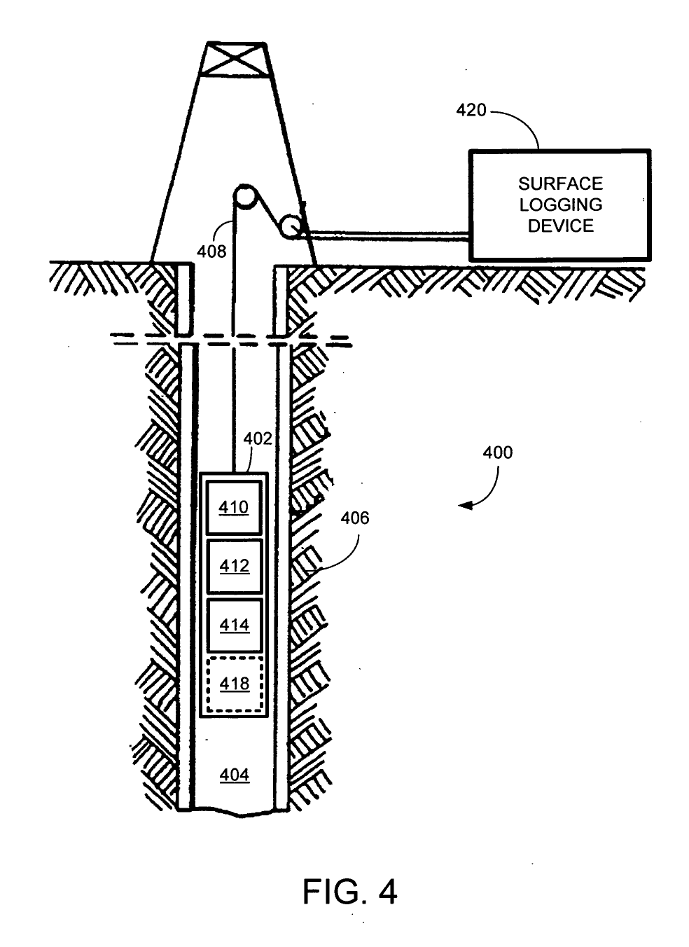

FIG. 4 illustrates a system 400 for reducing sensor data generated by a downhole device. The system 400 includes a downhole device 402. The downhole device 402 may be designed for placement in a borehole 404 that penetrates an earth formation 406. The downhole device 402 may be lowered into the borehole 404 by a cable 408. The downhole device 402 may be similar to the sonde 102 of FIG. 1 and may be configured for any number of data collection operations. For example, the downhole device 402 may be equipped for use in segmented bond logging, open-hole logging, production logging or other logging operations.

The downhole device 402 includes a sensor component 410 configured to produce sensor data. In one embodiment, the sensor component 410 acquires sensor data by emitting an acoustic pulse or other signal and recording its return waveform. As is customary in the art, the sensor component 410 may include a signal source and at least one receiver. The signal source typically produces a pulse that travels through the well/formation 406 and back to the device 402, where the receiver detects it. Regardless of the type of logging being performed, the sensor component 410 may generate sensor data to be used in evaluating the well and/or the formation 406. As will be appreciated by those skilled in the art, a variety of techniques exist for using sensor components with a downhole device, and the present invention is not limited to any particular type of sensor equipment or data collection methods.

The downhole device 402 also includes a wavelet transformation component 412. The wavelet transformation component 412 may be configured to apply a wavelet transformation (or wavelet filter) to the sensor data. The resulting dataset may be referred to as the filtered data. As previously discussed, a wavelet filter allows time-based amplitude data to be transformed into a wavelet domain. Any number of wavelet transformations known in the art may be acceptable for use by the wavelet transformation component 412, and a variety of techniques exist for applying wavelet transformations. For example, the wavelet transformation component 412 may utilize software being executed on a processor. Alternatively, the wavelet transformation component 412 may include a DSP (Digital Signal Processing) device that is capable of generating the filtered data.

A data reduction component 414 is also included in the downhole device 402. The data reduction component 414 may be configured to eliminate a portion of the data points from the filtered data to yield a reduced dataset. Depending on the received signal and the type of wavelet utilized, a significant number of the amplitude values in the filtered dataset may be zero or close to zero. These values may be eliminated from the filtered data by the data reduction component 414. Further, data points associated with noise may be identified and eliminated. After processing by the data reduction component 414, the reduced dataset may have significantly fewer data points than the original sensor data. Accordingly, the reduced dataset may be better suited for storage or transmission than the original data.

The system 400 also includes a surface logging device 416 configured to receive the reduced dataset from the downhole device 402. Once in possession of the reduced dataset, the surface logging device 416 may perform a variety of data processing operations and/or generate a well log. For example, the surface logging device 416 may apply an inverse wavelet transformation to the reduced dataset. As previously discussed, such a transformation may accurately reproduce the original sensor data.

Optionally, the downhole device 402 may include a data store 418 configured to store the reduced dataset. This form of memory logging allows the data to reside on the device 402 while the device 402 is downhole. Once the downhole device 402 is raised to the surface, the data store 418 may be accessed to retrieve the reduced dataset for further data processing/logging operations by the surface logging device 416. As will be appreciated by those skilled in the art, while storage of the unprocessed sensor data may quickly exceed the memory capacity of the data store 418, such a concern is minimized when only the reduced dataset is stored.

Alternatively, the cable 408 may be a wireline and may enable real-time transmission of the reduced dataset to the surface logging device 416. As the reduced dataset is only a fraction of the size of the actual sensor data, the transmission of the reduced dataset via a wireline may be accomplished without implicating the bandwidth limitations/data distortion problems currently associated with such wireline transmissions.

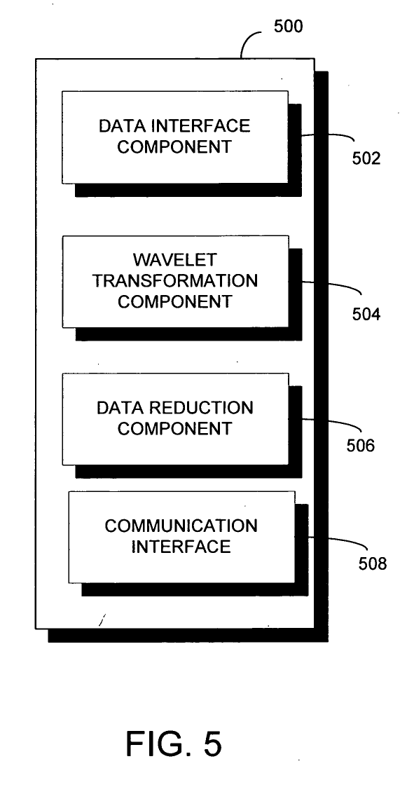

FIG. 5 illustrates a data processing device 500. In one embodiment, the data processing device 500 resides within or on a downhole device. For example, the data processing device 500 may reside within a device similar to the sonde 102 of FIG. 1. Because the data processing device 500 is located on a downhole device, it may be configured for processing data while the downhole device is located in a wellbore below the surface.

The data processing device 500 includes a data input component 502 configured to receive sensor data. For example, any number of sensor devices may reside on the downhole device and may be used to generate data for use in logging operations. In one embodiment, such sensor data is converted into digitized data and is communicated to the data input component 502.

A wavelet transformation component 504 is also included in the data processing device 500. The wavelet transformation component 504 may be configured to receive the sensor data from the data input component 502. Upon receipt of this data, the wavelet transformation component 504 may generate filtered data by applying a wavelet transformation to the sensor data. Techniques for applying such wavelet transformations are well known in the art, and the wavelet transformation component 504 may include a DSP device configured to perform the wavelet transformation.

The filtered data may then be communicated to a data reduction component 506. The data reduction component 506 may be configured to eliminate a portion of the data points from the filtered data to yield a reduced dataset. As discussed herein, the application of a wavelet transformation may allow numerous unnecessary data points to be identified and removed from the filtered data. Further, the wavelet transformation may allow data points associated with noise to be identified and removed. By leveraging the properties of wavelet transformations, the data reduction component 506 may eliminate unnecessary/unwanted data from the dataset, while retaining the meaningful data points.

A communication interface 508 is also included in the data processing device 500. The communication interface 508 may be configured to communicate the reduced dataset to either a data store residing on the downhole device or to a surface device via a wireline. Regardless of whether memory or wireline logging is being attempted, the communication interface 508 communicates only the reduced dataset and not the larger set of original sensor data. When a surface device receives the reduced dataset, an inverse wavelet transformation may be applied to the data. Such an inverse transformation will yield a reproduction of the original sensor data, and this reproduced sensor data may be used to create a well log.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. A method for processing sensor data generated by a downhole device, said method comprising:
receiving sensor data produced by said downhole device;
generating filtered data by applying a wavelet transformation to at least a portion of said sensor data, wherein said filtered data is comprised of a plurality of data points;
eliminating at least a portion of said plurality of data points from said filtered data to yield a reduced dataset; and
reproducing at least a portion of said sensor data by applying an inverse wavelet transformation to at least a portion of said reduced dataset.

2. The method of claim 1, wherein at least said generating and said eliminating are performed by said downhole device while said downhole device is located in a wellbore.

3. The method of claim 1, further comprising transmitting said reduced dataset via a wireline.

4. The method of claim 1, further comprising storing said reduced dataset in a data store on said downhole device.

5. The method of claim 1, wherein said eliminating removes one or more data points from said filtered data identified as residing above or below one or more predefined thresholds.

6. The method of claim 1, further comprising utilizing the reproduction of said sensor data to generate a log for use in evaluating a bond between a casing and cement placed in an annulus between said casing and a wellbore.

7. The method of claim 1, wherein said eliminating removes at least a portion of said plurality of said data points identified as representing noise.

8. A system for reducing sensor data generated by a downhole device, said system comprising:
a downhole device configured to be positioned in a wellbore, said downhole device comprising:
a sensor component configured to produce sensor data;
a wavelet transformation component configured to generate filtered data by applying a wavelet transformation to at least a portion of said sensor data, wherein said filtered data is comprised of a plurality of data points; and
a data reduction component configured to eliminate at least a portion of said plurality of data points from said filtered data to yield a reduced dataset; and
a surface logging device configured to receive said reduced dataset from said downhole device and further configured to reproduce at least a portion of said sensor data by applying an inverse wavelet transformation to at least a portion of said reduced dataset.

9. The system of claim 8, wherein said wavelet transformation utilizes at least one wavelet selected from the Daubechies family of wavelets.

10. The system of claim 8, wherein said downhole device further comprises a digital-to-analog converter configured to convert said sensor data into digitized data.

11. The system of claim 8, wherein said surface logging device is further configured to utilize the reproduced sensor data to create one or more well logs.

12. The system of claim 8, wherein said downhole device further comprises a data store configured to store said reduced dataset.

13. The system of claim 8, further comprising a wireline for connecting said downhole device and said surface logging device, wherein said wireline is configured to carry said reduced dataset from said downhole device to said surface logging device.

14. A data processing device residing on or within a downhole device and configured to process data while said downhole device is located in a wellbore, said data processing device comprising:
a data input component configured to receive sensor data;
a wavelet transformation component configured to generate filtered data by applying a wavelet transformation to at least a portion of said sensor data, wherein said filtered data is comprised of a plurality of data points;
a data reduction component configured to eliminate at least a portion of said plurality of data points from said filtered data to yield a reduced dataset; and
a communication interface configured to communicate said reduced dataset to at least one of a data store residing on or within said downhole device or a surface device via a wireline.

15. The data processing device of claim 14, wherein said sensor data is received from one or more sensor instruments residing on or within said downhole device.

16. The data processing device of claim 14, wherein said data reduction component is configured to eliminate from said filtered data one or more data points identified as residing above or below one or more predefined thresholds.

17. The data processing device of claim 14, wherein said wavelet transformation component is further configured to encrypt said sensor data with an encryption algorithm.

18. The data processing device of claim 17, wherein said encryption algorithm includes said wavelet transformation.

19. The data processing device of claim 14, wherein said data reduction component is configured to eliminate from said filtered data one or more data points identified as representing noise.

20. The data processing device of claim 14, wherein said surface device is configured to reproduce at least a portion of said sensor data by applying an inverse wavelet transformation to at least a portion of said reduced dataset.
